(19) United States
(12) Patent Application Publication
(10) Pub. No.: US 2026/0169780 A1
(43) Pub. Date: Jun. 18, 2026

(54) METHODS AND SYSTEMS FOR AUTOMATICALLY PARTITIONING A DIRECTED GRAPH OF NODES ASSOCIATED WITH A RULES-BASED SYSTEM

(71) Applicant: Red Hat, Inc., Raleigh, NC (US)

(72) Inventors: Edoardo Vacchi, Milan (IT); Paolo Antinori, Milan (IT)

(21) Appl. No.: 18/982,479

(22) Filed: Dec. 16, 2024

(51) Int. Cl. G06F 9/455; H04L 41/0894

(52) U.S. Cl. CPC G06F 9/45558; H04L 41/0894; G06F 2009/45595

(57) ABSTRACT

The present disclosure provides computer-implemented methods, systems, and devices for automatically partitioning a directed graph of nodes. A computing device accesses a directed graph of nodes, wherein the directed graph of nodes represents a rule-based system for evaluating input. The computing device partitions the directed graph of nodes into a router network and two or more partitions, each partition comprising an independent subsection of the directed graph of nodes. For a respective partition of the two or more partitions, the computing device generates a respective service container to store the respective partition. The computing device transmits the respective service container to a remotely located second computing system for execution on the remotely located second computing system.

### BACKGROUND

A rules-based system is a software system that executes a rules-based application made up of a plurality of rules. The rules typically include one or more conditions and an action that is taken based on the outcome of the conditions. Complex rules-based application can include hundreds or even thousands of rules.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can be performed by a computing system comprising one or more processors. The one or more operations comprise steps for automatically partitioning a directed graph of nodes that implement a rule-based system. The operations comprise accessing, by a first computing system, a directed graph of nodes, wherein the directed graph of nodes represent a rule-based system for evaluating input. The operations comprise partitioning, by the first computing system, the directed graph of nodes into a router network and two or more partitions, each partition comprising an independent subsection of the directed graph of nodes. For a respective partition of the two or more partitions, the operations comprise generating, by the first computing system, a respective service container to store the respective partition. The operations comprise transmitting, by the first computing system, the respective service container to a remotely located second computing system for execution on the remotely located second computing system.

Another example aspect of the present disclosure is directed to a computing system for automatically partitioning a directed graph of nodes. The system can include one or more processors and one or more non-transitory computer-readable media that collectively store instructions that, when executed by the one or more processors, cause the computing system to perform operations. The operations can include accessing a directed graph of nodes, wherein the directed graph of nodes represent a rule-based system for evaluating input. The operations can include partitioning the directed graph of nodes into a router network and two or more partitions, each partition comprising an independent subsection of the directed graph of nodes. For a respective partition of the two or more partitions, the operations include generating a respective service container to store the respective partition. The operations include transmitting the respective service container to a remotely located second computing system for execution on the remotely located second computing system.

Another example aspect of the present disclosure is directed to one or more non-transitory computer-readable media that collectively store instructions that, when executed by one or more computing devices, cause the one or more computing devices to perform operations. The operations can include accessing a directed graph of nodes, wherein the directed graph of nodes represent a rule-based system for evaluating input. The operations can include partitioning the directed graph of nodes into a router network and two or more partitions, each partition comprising an independent subsection of the directed graph of nodes. For a respective partition of the two or more partitions, the operations include generating a respective service container to store the respective partition. The operations include transmitting the respective service container to a remotely located second computing system for execution on the remotely located second computing system.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 depicts an example computing device according to example embodiments of the present disclosure;

FIG. 2A depicts an example directed graph in accordance with example embodiments of the present disclosure;

FIG. 2B depicts an example directed graph in accordance with example embodiments of the present disclosure;

FIG. 3 depicts a block diagram of an example computing system for automatically partitioning a directed graph of nodes according to example embodiments of the present disclosure;

FIG. 4 depicts an example graph analysis system in accordance with example embodiments of the present disclosure;

FIG. 5 is a flow diagram representing a process for automatically partitioning a directed graph of nodes in accordance with example embodiments of the present disclosure; and

FIG. 6 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

A rules based system can be a software system that executes a rules-based application made up of a plurality of rules. The rules typically include one or more conditions and an action that is taken based on the outcome of the conditions. Complex rules-based application can include hundreds or even thousands of rules. Many rules engines operate in accordance with the Rete algorithm designed by Dr. Charles Forgy. The Rete algorithm is a pattern matching algorithm for implementing rule-based systems. The algorithm was developed to efficiently apply many rules or patterns to many objects, or facts, in a knowledge base.

A Rete-based rules engine receives as input one or more specifications (e.g., a rules-based application) written in a predetermined syntax that identifies the rules and the relationship between the rules, such as an order of operation of the rules. A complex rules-based engine may implement hundreds or thousands of rules, and many of the rules may be interrelated to one another, such that they share some of the same conditions. The rules engine typically processes the specification to generate a Rete decision tree (sometimes referred to as a Rete graph, Rete network, or Rete discrimination tree).

Generally, the present disclosure is directed towards a system for partitioning a directed graph of nodes into independent sections that can be packaged and executed at different computing systems. To do so, a computing system can access a directed graph of nodes. The directed graph of nodes can represent a rule-based system, with each node in the directed graph representing a specific rule and each edge in the directed graph representing an outcome from applying the rule and providing the outcome to the next node (e.g., the node to which the edge is connected) in the directed graph of nodes. A graph analysis system can analyze the directed graph of nodes (e.g., using a breadth-first search or another appropriate method). The graph analysis system can identify two or more independent subsections within the directed graph of nodes. A containerization system can generate a service container for each independent subsection. The service container can be transmitted to a remote computing device while the remaining portions of the directed graph of nodes can remain at the original system and be referred to as a router network. When input is received at the router network, the router network can process the input until it reaches a node connected to one of the independent subsections. The computing system can transmit the output from the node to the remote computing system, which stores the associated service container. The remote computing system can finish processing the input using the independent subsection stored in the service container until it reaches one or more outcome in the subsection of nodes.

For example, a directed graph of nodes can be associated with an airline rewards system. The directed graph of nodes can take information about a transaction (including the user's identification number) as input and output the rewards to be granted for the transaction. Each node can represent a rule that can be applied to the transaction. The graph analysis system can analyze each rule as it moves through the graph of nodes. At each node, the graph analysis system can apply the rule to the input and generate an output based on the outcome of the rule. The graph analysis system can determine that once an initial section of nodes has been evaluated (e.g., determining the user's current status and whether the user is signed up for a particular incentive program), subsequent portions of the directed graph are independent of the rest of the directed graph. In this example, the graph analysis system can generate a plurality of service containers, each service container associated with the section of the directed graph of nodes that calculates outcomes for users with a particular user reward status (e.g., gold, silver, diamond). The service containers can be transmitted to a plurality of remote computing systems.

When the directed graph of nodes receives a transaction as input, the router network can process the transaction until it reaches one of the independent subsections (e.g., the graph has determined that the user associated with a particular transaction is a gold member but is not signed up for the Christmas travel promotion). The router network can transmit the transaction (and any information generated by the graph) to the associated remote computing system. The remote computing system can complete transaction processing using the independent subsection stored in the service container until one or more outcomes (e.g., actions) are reached. In this way, the amount of processing that the router network system needs to perform can be significantly reduced, and the overall system can perform analysis more quickly without a significant increase in the use of resources, time, or the total cost.

More particularly, a graph evaluation system can take an object or other piece of data as input, apply a plurality of rules from a rules-based graph, and output one or more results of the rules-based system (e.g., take an action or other outcome). The graph evaluation system can include a directed graph of nodes to apply the rules-based system. The directed graph of nodes can include a series of nodes and connections between them via edges. The graph evaluation system can determine the current node, apply the rule for that node to the input, determine the output for that rule, and select the one or more appropriate edges. In some examples, each node is connected to one or more other nodes by one or more edges. Each connection between a node and another node is an edge. In some examples, the output of a particular node is directed to only one node connected to the source node. In another example, the output from a node is transmitted to multiple nodes connected to the source node. In a directed graph, the edges between nodes only transmit data in a single direction. In this way, a parent node can provide output to a child node, but the child node does not return any output to the parent node because the edge is unidirectional.

In some examples, the directed graph of nodes is associated with a Rete algorithm. The directed graph of nodes can include a single root node. The root node can have a series of child nodes in a tree-based structure, each connected to the parent node by an edge. In some examples, the output of a parent node can be transmitted to only one child node out of the plurality of multiple child nodes. In some examples, the directed graph of nodes includes multiple types of nodes. For example, the graph may include alpha nodes and beta nodes. An alpha node can be a node that performs a simple conditional test that compares information associated with the input (e.g., stored in working memory) against a static rule. For example, an alpha node can determine whether a transaction amount associated with a current transaction is above or below $20. If the node determines that the transaction is above $20, a first child node can receive that output. In contrast, if the transaction is below $20, a second distinct child node can receive the output. Thus, the nodes against which a particular output is compared can be determined based on the outcomes of previous nodes.

Beta nodes can be nodes in which the output of two other nodes can be compared (e.g., a join). Continuing the above example, a particular reward may be conditional on a user's status and the time the transaction occurred. Thus, a beta node can determine whether the transaction was completed before the end of 2024 and whether the user has gold status. If both conditions are fulfilled, the beta node can output a positive output. Otherwise, that output can be negative. The combination of beta and alpha nodes can implement a very complex set of rules.

Once the directed graph of nodes has been accessed, a graph analysis system can analyze the graph to determine whether the graph includes any independent subsections of nodes. A subsection of the graph is determined to be independent if, after the initial subsection node, the nodes of the subsection only connect to other nodes within the subsection. A subsection is determined to be independent because it does not rely on any input from another portion of the graph (other than the initial subsection node) and does not provide input to any other portion of the graph. Instead, this portion can take input at the initial subsection node and continue to a resolution without receiving any input or providing any output to nodes outside the independent subsection of nodes.

Independent subsections of the directed graph can provide discrete services without interacting with other nodes in other sections of the directed graph of nodes. Thus, if the entire directed graph of nodes can be seen as providing a particular service, the one or more independent subsections can be determined to provide one or more sub-services. Because the sub-services can be provided independently of other portions of the directed graph (other than the initial subsection node), these independent subsections can be partitioned from the total directed graph of nodes and executed at a remote computing system.

Thus, once two or more independent subsections of the directed graph are identified, a containerization system can extract those subsections, including all the included nodes and edges, and provide a software package in which the subsection of the graph is included. The software package can include any components needed to execute the subsection of the directed graph at a remote computing system. This software package can be referred to as a service container.

Once a plurality of service containers, including independent subsections of the directed graph of nodes, are generated, the computing system can transmit each service container to an associated remote computing system. The remaining sections of the directed graph (referred to as a router network) can be updated to include information about the specific location of the remote computing system associated with each independent subsection. For example, an initial subsection node for a particular independent subsection can remain in the directed graph of nodes. When this node has been reached, the graph processing system can access the networking address for the associated remote computing system. The graph processing system can use this networking address to transmit information associated with a particular input (object) and any associated metadata or context data to the remote computing system currently executing the service container of the respective independent subsection. The remote computing system can then process the input to achieve an output (e.g., take an action as defined by the rule based system) based on the independent subsection. The result can be returned to a user or the original computing system (e.g., the computing system storing the router network) as needed.

In some examples, the portions of the directed graph of nodes that are not partitioned into subsections can be referred to as the router network. The router network can provide the initial processing of the input until the router network reaches an initial subsection node for an independent subsection of nodes. Once the graph processing system determines that an input is associated with an initial subsection node for a respective independent subsection of nodes, the graph processing system can transmit the output to the remote computing system associated with the respective independent subsection of nodes.

The remote computing system storing the service container of the respective subsection can further process the input. In some examples, the input includes the output of one or more nodes of the router network. Specifically, the output of the initial subsection node included in the respective subsection can be transmitted to the remote computing system. The remote computing system can finish processing the input and provide a result (e.g., taking an appropriate action or providing data to the computing system).

The systems and methods of the present disclosure provide a number of technical effects and benefits. As one example, the systems and methods can reduce the amount of memory needed and power used at a particular computing system by offloading the computation for at least some portions of evaluating the directed graph onto other computing devices. Doing so can allow simultaneous input processing, significantly reducing the time and cost needed to evaluate input using the directed graph of nodes.

With reference now to the Figures, example embodiments of the present disclosure will be discussed in further detail.

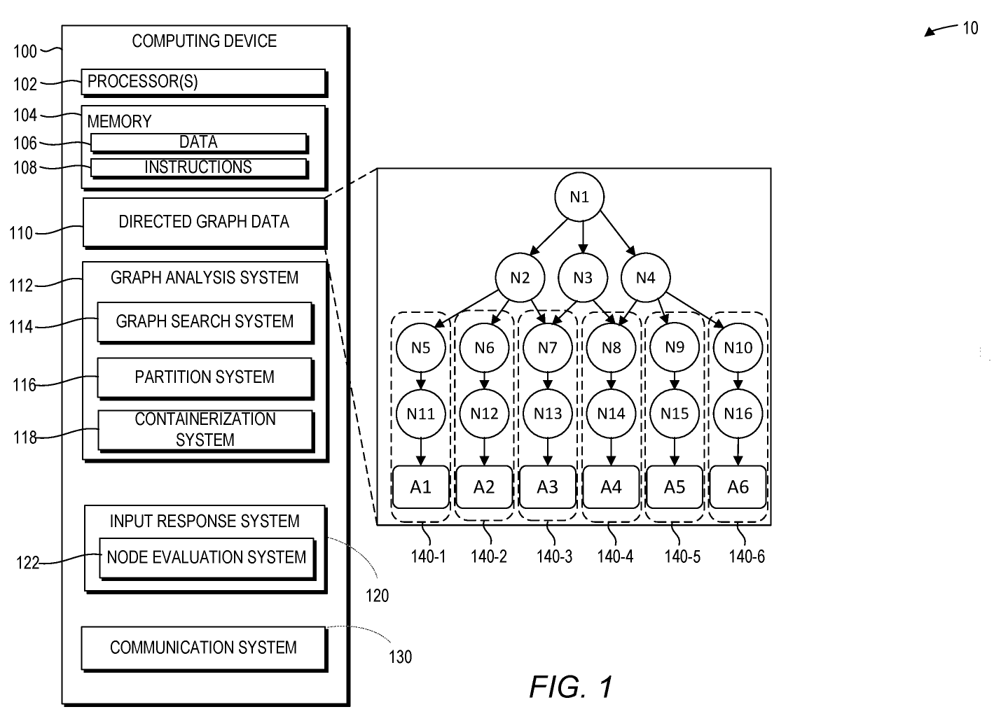

FIG. 1 depicts an example computing device 100 according to example embodiments of the present disclosure. In some example embodiments, the computing device 102 can be any suitable device, including, but not limited to a desktop computer, a tablet, a laptop, server computing system, or any other computer device that is able to perform the methods described herein. The computing device 100 can include one or more processor(s) 102, memory 104, directed graph data 110, a graph analysis system 112, an input response system 120, and a communication system 130.

The one or more processor(s) 102 can be any suitable processing device, such as a microprocessor, microcontroller, integrated circuit, or other suitable processing device. The memory 104 can include any suitable computing system or media, including, but not limited to, non-transitory computer-readable media, RAM, ROM, hard drives, flash drives, or other memory devices. The memory 104 can store information accessible by the one or more processor(s) 102, including instructions 108 that can be executed by the one or more processor(s) 102. The instructions can be any set of instructions that when executed by the one or more processor(s) 102, cause the one or more processor(s) 102 to provide the desired functionality.

In particular, in some devices, memory 104 can store instructions for implementing the graph analysis system 112, the input response system 120, and the communication system 130. The computing device 102 can implement the graph analysis system 112, the input response system 120, and the communication system 130 to execute aspects of the present disclosure, including automatically partitioning a directed graph of nodes, generating containers for the partitions, and processing input using the directed graph of nodes and its associated partitions.

It will be appreciated that the terms “system” or “engine” can refer to specialized hardware, computer logic that executes on a more general processor, or some combination thereof. Thus, a system or engine can be implemented in hardware, application-specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Memory 104 can also include data 106, such as directed graph data 110, that can be retrieved, manipulated, created, or stored by the one or more processor(s) 102. In some example embodiments, such data can be accessed and displayed to a user of the computing device 100 or transmitted to a remote computing system as needed.

In some example embodiments, the computing device 100 includes the graph analysis system 112, the input response system 122, and the communication system 130. The computing device 100 can store directed graph data 110. The directed graph data 110 can represent a rules-based system. The rules-based system (e.g., a Rete algorithm-based rules engine) can be represented by an acyclic-directed graph wherein nodes of the directed graph correspond to conditions or actions, and edges between nodes identify execution flow. Many of the nodes in the directed graph correspond to conditions, and a single node may represent an identical condition that is in several different rules, vastly increasing the efficiency of determining which rule, if any, a particular input meets.

The directed graph is structured such that a complete rule may be represented by a certain path through the nodes of the directed graph such that if each condition corresponding to a node in the path of nodes is met by an input, an action is taken. The rule-based system can generate processing node segments that correspond to the nodes in the directed graph. When executed by a computing device, the processing node segments can implement the corresponding node of the directed graph of nodes. Running instances of the processing node segments can be referred to herein as “processing nodes,” and at least some of the processing nodes implement conditional statements that operate on data contained in an input object.

Data is introduced into the rules-based system as input data that includes an input object. The object can include data fields that comprise the data. The input object can be evaluated beginning with a processing node segment associated with the root node (e.g., the initial subsection node) of the directed graph of nodes. The processing node can evaluate the data in the input object to determine whether it meets one or more conditions. Based on the result of that evaluation, the input object can be provided to one or more next processing node segments associated with one or more edges from the root node. In some examples, the input node is only provided to one subsequent processing node segment (e.g., if the node determines a type of transaction the input object is associated with and provides that input object to the next node in the directed graph of nodes associated with that type). In other examples, the input node (or information about that input node) can be provided to one or more subsequent nodes in the directed graph of nodes.

Thus, if the data in the input object (e.g., the data fields of the object) meet a condition, the transaction is processed by a processing node associated with the next processing node in the directed graph of nodes. If a particular input object reaches the end of a path, then the data in the object meets each condition, and one or more outcomes result (e.g., one or more actions are taken). The input and outcomes of any actions may be stored in a working memory that is accessed by the processing nodes. The rule-based system can generally process an input object more quickly and efficiently than other programming techniques that rely on sequential processing of nested IF-THEN-ELSE statements.

The graph analysis system 112 can perform an analysis of the directed graph data 110. This analysis aims to identify any portions of the directed graph of nodes represented in the directed graph data 110 that are independent subsections within the directed graph of nodes. An independent subsection can be a subsection of nodes within the directed graph of nodes that, other than an initial subsection node, does not include any subsequent nodes with edges that connect outside of the independent subsection. Because the graph is directed, the edges only flow in a single direction. A subsection can be determined to be independent by following the edges of each node below the initial subsection node and determining that none of the nodes provide output to or receive input from any nodes outside of the independent subsection.

In this simple example, the graph analysis system 112 can identify six independent subsections (140-1, 140-2, 140-3, 140-4, 140-5, 140-6). In each independent subsection in this example, none of the nodes in the independent subsection connects (via an edge) to a node not included in the independent subsection except for the initial subsection node for each independent subsection. For example, the only node in independent subsection 1 140-1 that connects to a node outside independent subsection 1140-1 is initial subsection node N5. The same is true for the independent subsections.

The graph analysis system can include a graph search system 114, a partition system 116, and a containerization system 118. A graph search system 114 can perform a breadth-first search of a directed graph of nodes represented in the directed graph data 110. A breadth-first search is a search of a graph or tree of nodes that examines each node on a particular level of depth before examining the next level of depth. Other search methodologies can be used.

Once the graph search system 114 has identified one or more independent subsections of the directed graph of nodes, a partition system 116 can be used to partition the directed graph of nodes. In some examples, the partition system 116 can identify an initial subsection node for each independent subsection. The initial subsection node can be the first node in the independent subsection. The partition system 116 can generate a partitioned independent subsection of the graph distinct from the directed graph data. The directed graph data 110 can also be updated so that the initial subsection node for the respective independent subsection remains in the directed graph (e.g., in the router network that remains after the independent subsection has been partitioned out). It includes information that can be used to identify a remote computing system that stores the independent subsection once it has been transmitted. In this way, if the computer device 100 processes input and arrives at the initial subsection node for the respective independent subsection, the computing device 100 can determine the location of the associated independent route subsection.

In some examples, the partition system 116 can partition the directed graph data 110 into a series of independent subsections and a router network. The router network can be the portion of the directed graph data that remains at the computing device 100 once a plurality of independent subsections have been partitioned out. The input response system 120 can initially process input by navigating the remaining directed graph data (the router network) until it arrives at an initial subsection node for an independent subsection.

Once the partition system 116 has partitioned the directed graph data 110 into a router network and a plurality of independent subsections, the containerization system 118 can generate a plurality of service containers. Each independent subsection of the directed node graph can be enclosed or encapsulated in a particular software container (referred to herein as a service container or a container image).

The phrase “container,” as used herein, refers to a running process that is isolated from other processes via namespaces and groups. A container is executed (e.g., initiated or instantiated) from a container image. A container image is a static package of software comprising one or more layers, the layers including everything needed to run an application (i.e., as a container) that corresponds to the container image, including, for example, one or more of executable runtime code, system tools, system libraries and configuration settings. A Docker® image is an example of a container image. A container image typically includes one or more file directories that include all executables, other than the host operating system kernel, necessary for the container to run. The life cycle of a container is managed by a container runtime, sometimes referred to as a container engine, such as, by way of non-limiting example, such as runC, crun, containerd, Docker, Windows Containers, and the like.

Containers are increasingly popular in cloud computing environments due, in part, to their lightweight footprint compared to a virtual machine (VM) and the speed at which a container can be initiated compared to a VM, while still maintaining strong isolation characteristics such that two containers executing in different namespaces on the same host are not inherently aware of one another and cannot negatively impact one another.

Once the containerization system 118 has generated a container for each independent subsection of the graph of nodes, the plurality of containers can be transmitted to remote computing systems. Each remote computing system can be communicatively coupled to the computer device 100 over a communication network. In some examples, the communication system 130 can be used to transmit the plurality of containers to a plurality of remote computing systems. In some examples, the remote computing systems are controlled by the same entity that controls the computer device 100. In this way, the portions of the directed graph of nodes can be spread amongst the plurality of different computer devices to reduce the load and increase processing throughput, but the ultimate control of the entire directed graph of nodes remains with the same entity (e.g., organization, company, user, etc.)

The directed graph of nodes can be partitioned to remove independent subsections. Each independent subsection can be packaged in a service container. Service containers for the different partitions can be spread amongst the plurality of different remote computing systems. Once this has been completed, the input response system 120 can receive a request to process an input. Input can include an input object that includes multiple data fields. The node evaluation system 122 can access a node processing system associated with the initial subsection node (e.g., N1). The node evaluation system 122 can determine whether one or more rules associated with the initial subsection node are satisfied by the input object (e.g., the data included in the object.)

Once the node evaluation system 122 has evaluated the input object with respect to the rule associated with the initial subsection node (N1), the input response system 120 can determine one or more next nodes to process based on the evaluation performed by the node evaluation system 122. In some examples, the outcome of this comparison can be transmitted to one or more other nodes. The input response system 120 can continue to process processing node systems based on each subsequent node reached. In some examples, the input response system 120 can reach an outcome node (e.g., an action node) in the directed graph of nodes. In this case, the computing system can perform the outcome indicated by the outcome node (e.g., an action or other outcome).

In some examples, the input response system 120 can reach an initial subsection node for an independent subsection of nodes. If so, the input response system 120 can analyze the initial subsection node to determine the location of the corresponding independent subsection of nodes from the directed graph of nodes. Using this information, the input response system 120 can transmit, using the communication system 130, information to the associated remote computing system. The information can include information included in the initial object and its data fields and any information generated by the directed graph of nodes while processing the input.

Once the relevant information has been sent to the remote computing system, an input response system included in the container for the independent subsection of nodes can process the input further using the information about the nodes included in the container. This processing can continue until the input processing system at the remote computing system reaches an action indicated in the independent subsection of nodes. In some examples, the remote computing system can transmit the action to the communication system 130, and the computing device 100 can perform the associated action.

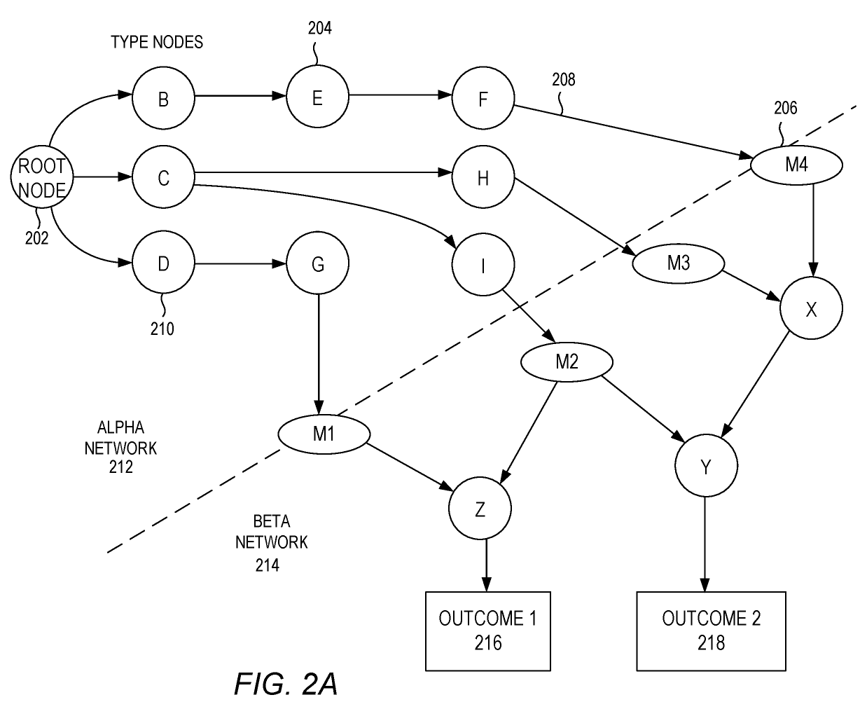

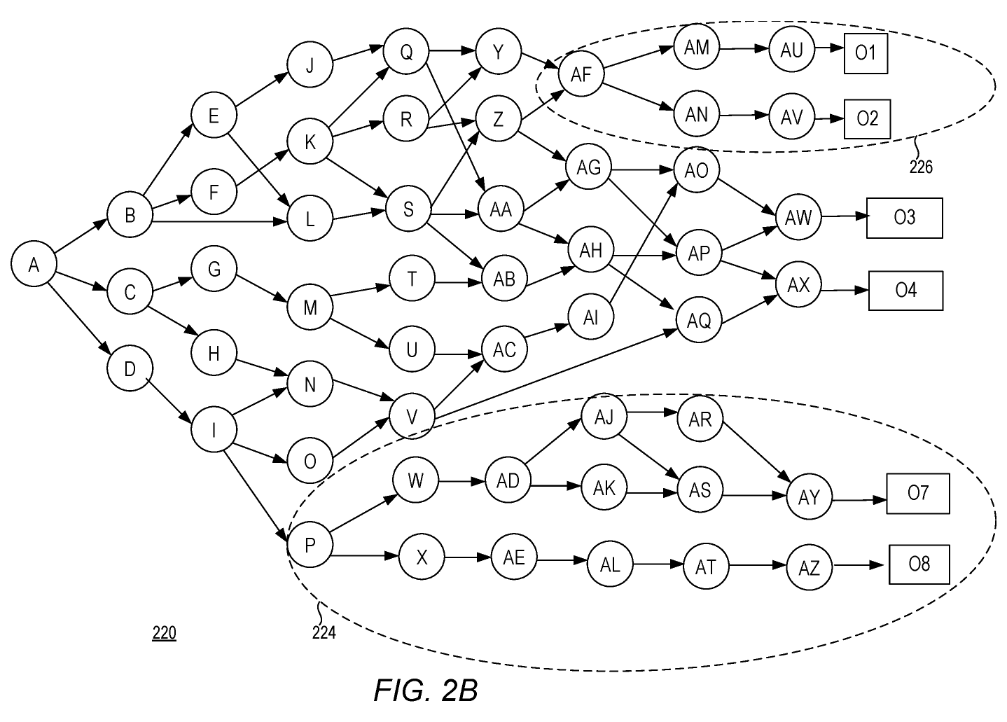

FIG. 2A depicts an example directed graph of nodes in accordance with example embodiments of the present disclosure. In this example, a directed graph of nodes includes a root node 202, a plurality of subsequent nodes 204 (e.g., nodes B-I and X-Z), a plurality of memory stores 206 (e.g., M1-M4), and a plurality of edges 208 that connect the nodes based on relationships between the nodes and the memory stores.

In this example, each node can have a type. The type can include the root node 202, type nodes 210, alpha nodes (e.g., nodes in alpha network 212), and beta nodes (e.g., nodes in the beta network 214). The root node 202 can be a first node that initially processes the input (e.g., an input object containing one or more data fields) to determine a path in the directed graph of nodes based on the data associated with the input.

Type node (e.g., such as node 210) can enable a selection that routes the input based on the particular type of information contained in the input. For example, a rule-based system can implement a rule that users get a five percent discount if they are younger than 12, older than 65, or have a yearly income of less than $25000. A type node can determine that age data can be provided to nodes that determine if the user is younger than 12 or older than 65, and income data can be provided to a node that determines whether the user’s income is less than $25000. Thus, the type node can provide the appropriate information from the information fields in the input object to the nodes that need that information.

An alpha node (e.g., a node that is part of the alpha network 212 such as nodes B-I) can receive a single piece of data as input and can perform simple comparisons on the piece of data. For example, an alpha node can determine whether the age of the user is less than 12. Another alpha node can determine whether the age of the user is greater than 65. Each node can output data representing the result of the comparison.

A beta node (e.g., a node in the beta network 214 such as nodes X-Z) can compare the output from two or more alpha nodes. For example, a beta node can perform an OR operation determination. For example, the beta node can receive an output from an alpha node that determines whether the user’s age is less than 12 and an alpha node that determines whether the user’s age is greater than 65. If either of these outputs is true, the beta node can determine that the requirement is met (e.g., that the user is either older than 65 or younger than 12).

The directed graph can include outcome nodes such as outcome node 1216 and outcome node 2218. When the system reaches the outcome node, the system determines that the input is associated with performing that action. For example, a potential rule can include that if the user is under 12, over 65, or earns less than $25000, the system can apply a 10% discount. Thus, if the graph evaluation system meets the requirements (based on applying all the necessary rules), the system can take an action that applies a 10% discount to the current transaction.

FIG. 2B depicts an example directed graph of nodes in accordance with example embodiments of the present disclosure. The directed graph 220 has been simplified from the example in FIG. 2A to demonstrate independent subsections.

In this example, there are two significant independent subsections in the directed graph 220. Independent subsection 1224 begins at node P, which is the initial subsection node for independent subsection 1224. Independent subjection 2226 begins at node AF, which is the initial subsection node for independent subsection 2226.

As can be seen, independent subsection 1224 includes 15 nodes (two of which are outcome nodes (O7 and O8)). None of the nodes in independent subsection 1224 (other than initial subsection node P) connects to any node outside of the independent subsection 1224. In this way, the graph analysis system can determine that subsection 1 is independent from the rest of the directed graph 220.

Similarly, independent subsection 2226 includes 7 nodes (two of which are outcome nodes (O1 and O7)). None of the nodes in independent subsection 2226 (other than initial subsection node AF) connects (via an edge of the graph) to any node outside of the independent subsection 2226. In this way, the graph analysis system can determine that subsection 2 is independent from the rest of the directed graph 220.

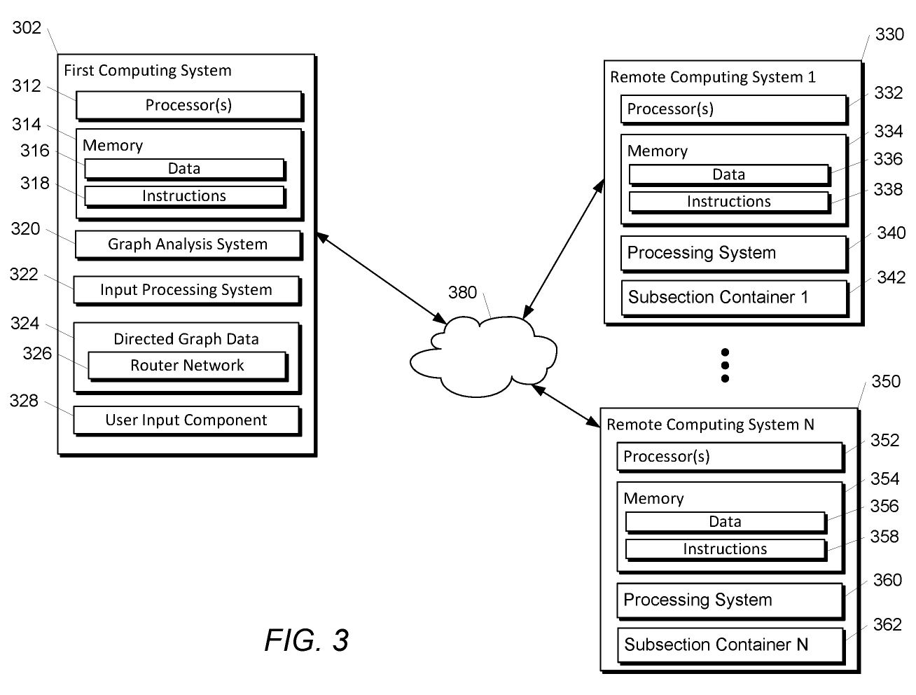

FIG. 3 depicts a block diagram of an example computing system 300 for automatically partitioning a directed graph of nodes according to example embodiments of the present disclosure. The computing system 300 includes a first computing system 302, one or more remote computing systems (e.g., remote computing system 1332 and remote computing system N 350) that are communicatively coupled over a network 380.

The first computing system 302 can be any type of computing device, such as a personal computing device (e.g., laptop or desktop), a server computing device, a tablet computer, an embedded computing device, or any other type of computing device.

The first computing system 302 includes one or more processors 312 and a memory 314. The one or more processors 312 can be any suitable processing device (e.g., a processor core, a microprocessor, an ASIC, an FPGA, a controller, a microcontroller, etc.) and can be one processor or a plurality of processors that are operatively connected. The memory 314 can include one or more non-transitory computer-readable storage mediums, such as RAM, ROM, EEPROM, EPROM, flash memory devices, magnetic disks, etc., and combinations thereof. The memory 314 can store data 316 and instructions 318, which are executed by the processor 312 to cause the first computing system to perform operations.

The first computing system 302 can also include one or more user input components 328 that receive user input. For example, the user input component 328 can be keyboard or a mouse. The input component can include a touch-sensitive component (e.g., a touch-sensitive display screen or a touchpad) that is sensitive to the touch of a user input object (e.g., a finger or a stylus). The touch-sensitive component can serve to implement a virtual keyboard. Other example user input components include a microphone, or other means by which a user can provide user input.

In some implementations, the first computing system 302 can store or include a graph analysis system 320, an input processing system 322, and directed graph data 324. The graph analysis system 320 can access the directed graph data 324 to identify a plurality of independent graph subsections within the directed graph of nodes represented in the directed graph data 324.

A subsection of the graph data is determined to be independent when that subsection includes nodes that only connect (e.g., via edges) to other nodes within the subsection. If a subsection is independent, there are no edges between nodes within the independent subsection and nodes outside of the independent subsection other than the initial subsection node that begins the independent subsection (which is connected to its parent node). As discussed above, the graph analysis from 320 can perform a search of the directed graph data 324 to identify the independent subsections. Specifically, the graph analysis system 320 can perform the breadth-first search that determines, for each node of the graph, whether it connects to nodes that are outside of the current subsection.

Each independent subsection can have an initial subsection node, which is the first node in the directed graph of nodes included in the independent subsection. The graph analysis system can remove it from the directed graph of nodes in the directed graph near 324. Once all of the independent subsections have been partitioned out of the graph, the remaining graph of nodes can be referred to as the router network 326. The router network 326 can be the portion of the directed graph of nodes used to determine which independent subsection needs to be accessed for any particular input.

An input processing system 322 can receive input from a requesting user (e.g., an organization or person). In some examples, the input can include an object with one or more data fields. The data fields can include the information used to evaluate the input at each node in the directed graph of nodes. The input processing system 322 can use the input (e.g., the object) and access a node processing system associated with the root node of the directed graph.) A node processing system can perform an evaluation of a rule associated with a particular node. As discussed above, the node processing system can enable the input processing system to determine, for a respective node, whether the input meets one or more criteria of a rule associated with the respective node. For example, a node processing system can determine whether a particular value is greater or less than a threshold, determine whether the text of a value matches a reference text, or perform other simple comparison functions.

In some examples, the input processing system can determine whether the condition is met based on a previous node’s output. For example, if the outputs of two previous nodes both need to be true for the output of the current node to be true, the node processing system can access those outputs (e.g., from a basic node storage memory) and determine whether both are true and generate and output based on the result of the determination. After each comparison, the input processing system 322 can provide the output to subsequent node processing systems based on the edges that connect nodes to nodes. In some examples, a failure to meet the condition will end up with a particular input. In other examples, the output can be provided to subsequent nodes regardless of whether the condition is evaluated to be true or false.

The input processing system 322 can continue progressing through the directed graph of nodes based on the router network 326. The processing can end when the input processing system 322 reaches an endpoint. An endpoint can be an outcome such as an action that the system needs to take in response to the input. In other examples, the input processing system can determine that no action is needed because the input does not meet the conditions for a particular outcome. In other examples, the input processing system 322 can reach an initial subsection node for an independent subsection. This initial subsection node for an independent subsection can represent an end of processing for the router network. Further processing will be performed by the container containing the independent subsection of nodes at a remote computing system (e.g., 330 or 350).

In the router network 326, an initial subsection node for the independent subsection can include, with other information, information to contact the remote computing system that hosts the independent section of the router network, such as a network address. For example, when each independent subsection has been containerized, it can be transmitted to a particular remote computing system (e.g., 330, 350, or a remote computing system not pictured). The information for connecting to that remote computing system can be stored with the initial subsection node for that independent subsection. When the input processing system 322 reaches that initial subsection node, it can automatically determine where to send information to continue processing the input at the appropriate remote computing system.

The directed graph data 324 includes information describing a directed graph of nodes, including each node in the directed graph of nodes and each edge (e.g., which connects one node to another). In some examples, the directed graph data can include information to access the node processing system for each particular node and/or information about the specific rule to be applied by that node. Each node can be associated with a rule in a rule-based system, and each edge can be associated with transmitting output from a particular node to one or more other nodes.

The router network 326 is a subset of the directed graph of nodes that has been segmented or partitioned to remove a plurality of independent subsections. Each independent subsection can be packaged into a container and transmitted to a remote computing systems. The portions of the directed graph that cannot be packaged into a container and transmitted can remain as a router network 326 for evaluating inputs before determining which remote computing system the input needs to be transmitted to.

Thus, input received at the first computing system 302 can be processed by the router network 326 until an independent section of the directed graph of nodes that has been partitioned is reached. In this case, the first computing system 302 can transmit the input (or any required data) to the indicated remote computing system for further processing.

The remote computing systems (e.g., remote computing system 1330 and remote computing system N 350) include one or more processors (e.g., 332 or 352) and a memory (e.g., 334 or 354). The one or more processors 332 can be any suitable processing device (e.g., a processor core, a microprocessor, an ASIC, an FPGA, a controller, a microcontroller, etc.) and can be one processor or a plurality of processors that are operatively connected. The memory (e.g., 334 or 354) can include one or more non-transitory computer-readable storage mediums, such as RAM, ROM, EEPROM, EPROM, flash memory devices, magnetic disks, etc., and combinations thereof. The memory (e.g., 334 or 354) can store data (e.g., 336 or 356) and instructions (e.g., 338 or 358) which are executed by the processor (e.g., 332 or 352) to cause the remote computing systems (e.g., remote computing system 1330 and remote computing system N 350) to perform operations.

In some implementations, the remote computing systems (e.g., remote computing system 1330 and remote computing system N 350) include or are otherwise implemented by one or more server computing devices. In instances in which remote computing systems (e.g., remote computing system 1330 and remote computing system N 350) include plural server computing devices, such server computing devices can operate according to sequential computing architectures, parallel computing architectures, or some combination thereof.

As described above, the remote computing system 330 can store or otherwise include a processing system (e.g., processing system 340 or processing system 360) and a subsection container (e.g., subsection container 1342 or subsection container N 362). The subsection container can contain an independent subsection of the directed graph of nodes described in the directed graph data 324. The subsection container can also contain any information or instructions necessary to use the independent subsection to analyze input from the first computing system 302.

A processing system 340 can receive the subsection container 342 from the first computing system 302. The subsection container can provide a particular service associated with the independent section of the directed graph of nodes. Once the subsection container has been received, the processing system (e.g., 340 or 360) can receive input from the first computing system 302 when input is determined to be associated with the independent subsection of the graph included in this subsection container.

The input can include an object with data fields, data from one of the data fields, data produced by earlier portions of the directed graph notes, and any other relevant data needed to process the input at the independent subsection of nodes. The processing system can process the input by accessing a node processing system for the initial subsection node and determining the outcome based on that analysis. The outcome can then be transmitted to nodes connected to the initial subsection node by edges, and each subsequent node can be calculated again. In some examples, the processing will transmit data to only one of one or more nodes(e.g., if the node represents the rule determining a type of input or whether the specific condition is true) or to all of the nodes connected to the current node through edges.

The processing system 340 can continue to process nodes and evaluate the input until it reaches an ending note. The ending node can be associated with a particular action (e.g., if the condition is met for that action to occur) or non-action if no action is associated with the input. In some examples, the output can be transmitted back to the first computing system 302 for action to be taken. In other examples, the computing system can transmit instructions to perform an action directly to another system associated with taking that action.

The network 380 can be any type of communications network, such as a local area network (e.g., intranet), wide area network (e.g., Internet), or some combination thereof and can include any number of wired or wireless links. In general, communication over the network 380 can be carried via any wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

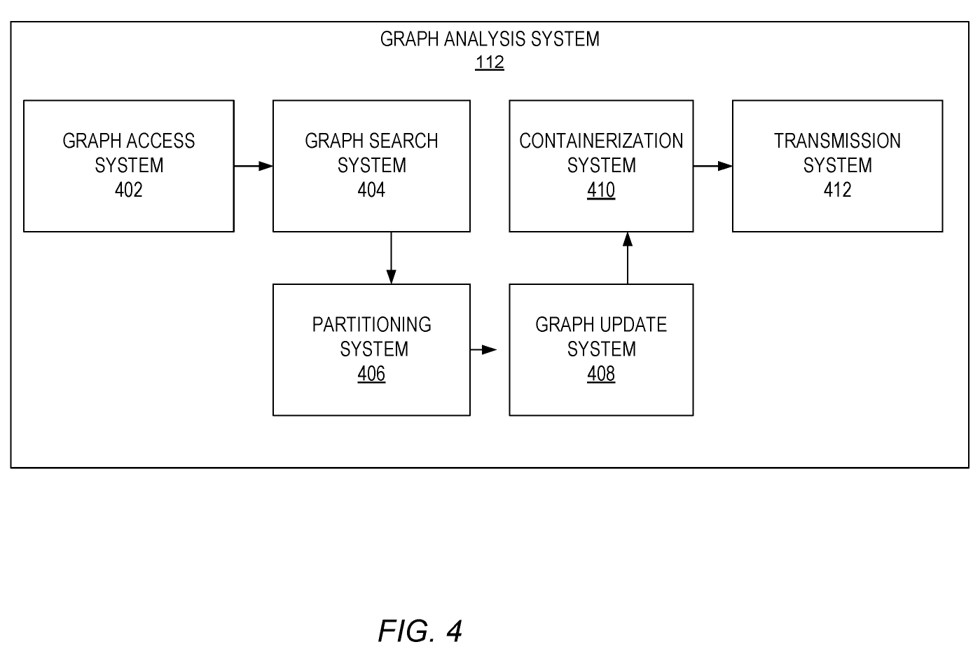

FIG. 4 depicts an example graph analysis system 112 in accordance with example embodiments of the present disclosure. The graph analysis system 112 can include a graph access system 402, a graph search system 404, a partitioning system 406, a graph update system 408, a containerization system 410, and a transmission system 412.

Graph access system 402 can access data describing a directed graph of nodes. The directed graph of nodes can be used to implement a rules-based system that takes an object as input, analyzes the object in accordance with the series of rules, and takes one or more actions based on the data fields, including the object and the rules implemented by the rules-based system.

The directed graph can include a series of nodes beginning at a root node and connected by one or more edges to other nodes. Each node can be associated with a rule in the rule-based system. The computing system can process a node by performing an evaluation of the input data (e.g., the data fields included in the object) based on the rule associated with the node. In some examples, a node can be processed based on the output from previously executed nodes. In some examples, the end of a particular line of nodes can be associated with an outcome. The outcome can include performing the action.

Once the graph axis system 402 has accessed the graph theory describing the directed graph of nodes, the graph data can be provided to the graph search system 404. The graph search system 404 can perform a search or other analysis of the directed graph of nodes to determine whether the directed graph of nodes includes any independent subsections. This search can be conducted automatically, and the determination can be made without any user feedback.

Independent subsections can include a particular initial subsection node for the subsection and all subsequent nodes connected to the initial subsection node through edges. A subsection of the graph can be independent if the graph search system determines that the nodes included in the independent subsection do not connect via an edge to any nodes outside of the independent subsection. That is to say, none of the nodes within the independent subsection receive output from any other nodes in the portion of the graph outside of the independent subsection, and none of the nodes provide their output to any node outside of the independent subsection. This determination can enable the independent subsection to operate as an independent entity without the need for input from or the need to provide input to any other portion of the directed graph of nodes.

In some examples, the graph search system 404 can perform a breadth-first search of the directed graph of nodes. In so doing, the graph search system 404 can analyze the nodes using a breadth-first search in which the first layer of nodes is analyzed before analyzing the second layer of nodes (e.g., the child nodes of the first layer). The graph search system 404 can maintain a list of possible subsections and continually check them for independence as it descends through the directed graph of nodes. In some examples, the graph search system 404 can return a list of independent subsections and provide them to the partitioning system 406.

The partitioning system 406 can determine which independent graph subsections should be partitioned from the directed graph nodes based on the information provided by the graph search system 404. In some examples, determining whether a particular independent subsection should be partitioned from the rest of the directed graph nodes can be based, at least in part, on a determination of whether the independent subsection provides a particular sub-service that would be useful. Thus, each independent subsection can be analyzed to determine whether the section of the rules-based system it represents is a useful sub-service based on the inputs to the independent subsection and the potential outcomes.

In some examples, the partitioning system 406 can determine whether or not to partition that independent subsection of nodes from the main portion of the directed graph of nodes based, at least in part, on the number of nodes included in the independent subsection. For example, the partitioning system 406 will not partition a large number of very small independent subsections from the directed graph of nodes because doing so would be inefficient.

The partitioning system 406 can determine which independent graph of node subsections should be partitioned from the directed graph of nodes and which should remain with the directed graph of nodes (e.g., the router network). This information can be provided to the graph update system 408.

The graph update system 408 can update the directed graph of nodes. For example, each independent subsection that is determined to be partitioned can be represented in the remaining route network (e.g., all the nodes not partitioned into independent subsections) by a single initial subsection node. The single initial subsection node can provide information about the location of the newly partitioned independent subsection and any other contextual information that may be useful to know. For example, the specific sub-services provided by the independent subsection can be provided, as well as information about the number of nodes that have been removed and the amount of time that may be needed when processing input at the independent subsection. This information can be used to predict potential outcomes and the amount of processing time that may be expected. The graph update system 408 can update the directed graph of nodes to remove all the independent subsections. The remaining section of the directed graph of nodes can be referred to as the router network. The router network can be a portion of the directive graph of nodes that provides initial analysis and categorizes inputs before transmitting inputs to the relevant independent subsection as needed.

The independent subsections of the directed graph of nodes can be provided to the containerization system 410. The containerization system 410 can generate software containers for each independent subsection of the graph. The containerization system 410 can comprise any suitable containerization technology or containerization technologies capable of generating a container image, such as, by way of non-limiting example, Open Shift, Docker, Kubernetes, or the like, modified as discussed herein. The phrase "container" as used herein refers to Linux containers wherein the Linux kernel features cgroups and namespaces are used to isolate processes from one another. The phrase "container" or "container image" as used herein refers to a static package of software comprising one or more layers, the layers including everything needed to run an application (i.e., as a container) that corresponds to the container image, including, for example, one or more of executable runtime code, system tools, system libraries and configuration settings. A Docker® image is an example of a container image.

The containerization system 410 can generate a container or container image for each independent subsection of nodes identified by the graph update system 408. Once a plurality of containers (also referred to a service containers) or container images are generated, the containerization system 410 can provide it to the transmission system 412. The transmission system 412 can transmit the containers to a plurality of remote computing systems.

Each remote computer system can store one or more of the service containers and can process input received from the router network or the computing system that currently executes the router network. A large number of inputs can be processed by the router network to determine which subsections of the graph should process the input. Based on that determination, the router network can transmit the input to the appropriate remote computing system. In this way, the workload can be handled without overburdening a single central computing system.

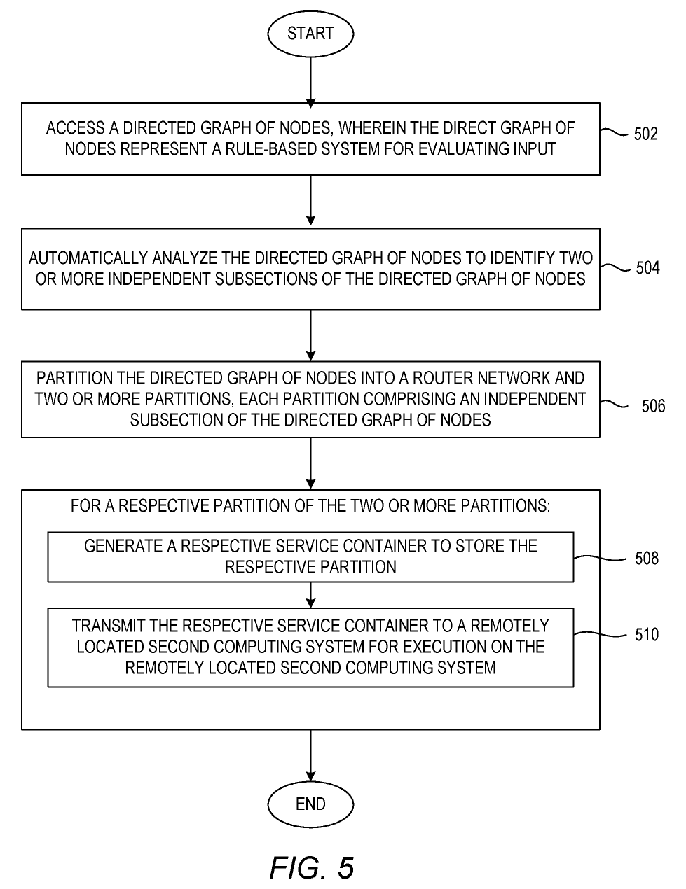

FIG. 5 is a flow diagram representing a process for automatically partitioning a directed graph of nodes in accordance with example embodiments of the present disclosure. The process can be performed by a computing system. The computing system can comprise one or more processors and one or more non-transitory computer-readable media that store instructions. The computing system can include a graph analysis system. The graph analysis system can, at 502, access, by a first computing system, a directed graph of nodes, wherein the directed graph of nodes represent a rule-based system for evaluating input.

In some examples, each node represents a rule in the rule-based system, and each edge in the directed graph represents a connection between a first node and a second node wherein an output of a first node is provided to the second node. The directed graph includes a root node connected to a plurality of child nodes via unidirectional edges.

In some examples, the graph analysis system can, at 504, automatically analyze the directed graph of nodes to identify two or more independent subsections of the directed graph of nodes. In some examples, the graph analysis system can identify independent sections by performing a breadth-first search of the directed graph beginning at the root node to identify an independent subsection of the directed graph of nodes.

A respective subsection begins at an initial subsection node and is determined to be independent if the nodes in the respective subsection do not connect via an edge to any node outside of the respective subsection. Once the respective subsection has been partitioned from the router network, the graph analysis system can update the router network to include a reference to a location of the remotely located second computing system storing the service container associated with the respective subsection.

In some examples, the reference to the location of the service container is associated with the initial subsection node in the router network. The directed graph can be associated with providing a service, and a respective partition in the two or more partitions can be associated with a sub-service.

The graph analysis system can, at 506, partition the directed graph of nodes into a router network and two or more partitions, each partition comprising an independent subsection of the directed graph of nodes. For a respective partition in the two or more partitions, the graph analysis system can, at 508, generate a respective service container for the respective partition.

The service container is a package of software that contains all necessary elements to execute on the remotely located second computing system. The graph analysis system can, at 510, transmit the respective service containers to a remotely located second computing system for execution on the remotely located second computing system.

The graph analysis system can receive an input request. The input request can include an input object with a plurality of data fields, each with a value. The graph analysis system can evaluate the input request using the router network, beginning at a root note and following the directed graph until the system reaches the initial subsection node associated with the respective subsection. The graph analysis system can identify the location of the remotely located second computing system storing the service container of the respective subsection.

The graph analysis system can transmit to the identified remotely located second computing system storing the service container of the respective subsection. In some examples, the input request includes an object to be evaluated based on the rules-based system.

The graph analysis system can apply at a respective node, the rule associated with the respective node to the object. The graph analysis system can evaluate an outcome of the rules associated with the respective node. The graph analysis system can provide the outcome of the evaluation to at least one additional node based on one or more edges connecting to the respective node.

The graph analysis system can continue to apply the rules associated with each additional node until the first computing system reaches an end of the directed graph or a reference to a service container located at a remotely located second computing system.

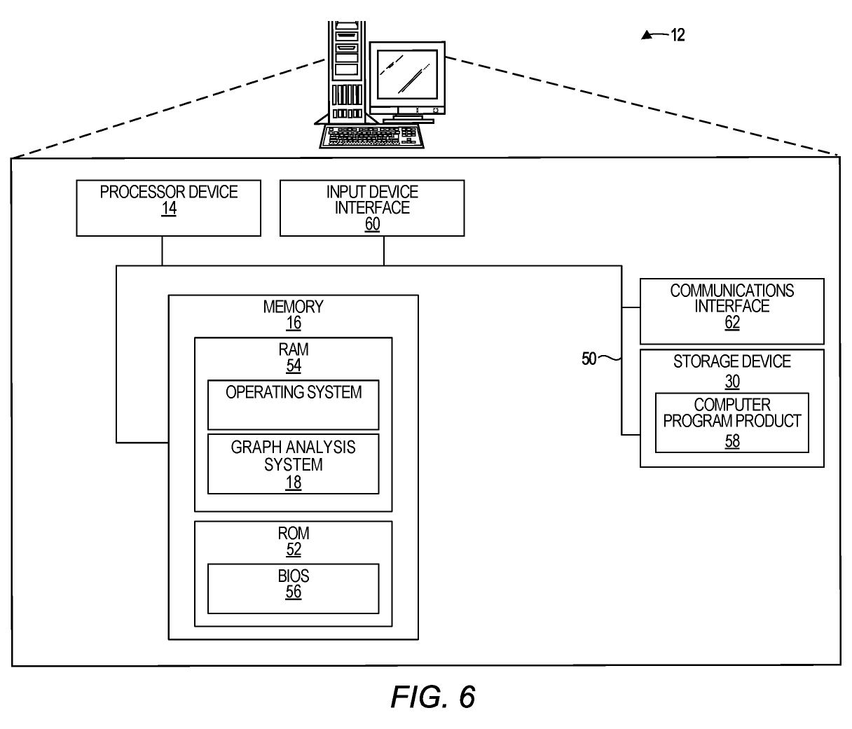

FIG. 6 is a block diagram of the computing device 12 suitable for implementing examples according to one example. The computing device 12 may comprise any computing or electronic device capable of including firmware, hardware, and/or executing software instructions to implement the functionality described herein, such as a computer server, a desktop computing device, a laptop computing device, or the like. The computing device 12 includes the processor device 14, the system memory 16, and a system bus 50. The system bus 50 provides an interface for system components including, but not limited to, the system memory 16 and the processor device 14. The processor device 14 can be any commercially available or proprietary processor device.

The system bus 50 may be any of several types of bus structures that may further interconnect to a memory bus (with or without a memory controller), a peripheral bus, and/or a local bus using any of a variety of commercially available bus architectures. The system memory 16 may include non-volatile memory 52 (e.g., read-only memory (ROM), erasable programmable read-only memory (EPROM), electrically erasable programmable read-only memory (EEPROM), etc.), and volatile memory 54 (e.g., random-access memory (RAM)). A basic input/output system (BIOS) 56 may be stored in the non-volatile memory 52 and can include the basic routines that help to transfer information between elements within the computing device 12. The volatile memory 54 may also include a high-speed RAM, such as static RAM, for caching data.

The computing device 12 may further include or be coupled to a non-transitory computer-readable storage medium such as the storage device 20, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 30 and other drives associated with computer-readable media and computer-usable media may provide non-volatile storage of data, data structures, computer-executable instructions, and the like.

A number of modules can be stored in the storage device 20 and in the volatile memory (e.g., RAM 54), including an operating system and one or more program modules, such as the graph analysis system 18, which may implement the functionality described herein in whole or in part. All or a portion of the examples may be implemented as a computer program product 58 stored on a transitory or non-transitory computer-usable or computer-readable storage medium, such as the storage device 20, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the graph analysis system 18 in the volatile memory 54, may serve as a controller, or control system, for the computing device 12 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 14 through an input device interface 60 that is coupled to the system bus 50 but can be connected by other interfaces such as a parallel port, an Institute of Electrical and Electronic Engineers (IEEE) 1394 serial port, a Universal Serial Bus (USB) port, an IR interface, and the like. The computing device 12 may also include a communications interface 62 suitable for communicating with a network as appropriate or desired.

Individuals will recognize improvements and modifications to the preferred examples of the disclosure. All such improvements and modifications are considered within the scope of the concepts disclosed herein and the claims that follow.

What is claimed is:

1. A computer-implemented method, comprising:
accessing, by a first computing system, a directed graph of nodes, wherein the directed graph of nodes represents a rule-based system for evaluating input;
partitioning, by the first computing system, the directed graph of nodes into a router network and two or more partitions, each partition comprising an independent subsection of the directed graph of nodes; and
for a respective partition of the two or more partitions:
generating, by the first computing system, a respective service container to store the respective partition; and
transmitting, by the first computing system, the respective service container to a remotely located second computing system for execution on the remotely located second computing system.

2. The computer-implemented method of claim 1, wherein the directed graph of nodes comprises a plurality of nodes and a plurality of edges connecting the plurality of nodes.

3. The computer-implemented method of claim 2, wherein each node of the plurality of nodes in the directed graph of nodes represents a rule in the rule-based system.

4. The computer-implemented method of claim 3, wherein each edge of the plurality of edges represents a connection between a first node and a second node of the directed graph of nodes wherein an output of the first node is provided to the second node.

5. The computer-implemented method of claim 2, wherein the directed graph of nodes includes a root node connected to a plurality of child nodes via corresponding unidirectional edges.

6. The computer-implemented method of claim 5, wherein partitioning, by the first computing system, the directed graph of nodes into the router network and the two or more partitions further comprises:
automatically analyzing, by the first computing system, the directed graph of nodes to identify two or more independent subsections of the directed graph of nodes, wherein each independent subsection comprises a respective first subsection node and a plurality of subsequent subsection nodes.

7. The computer-implemented method of claim 6, wherein automatically analyzing, by the first computing system, the directed graph of nodes to identify the two or more independent subsections of the directed graph of nodes further comprises:
performing, by the first computing system, a breadth-first search of the directed graph of nodes beginning at the root node to identify the two or more independent subsections of the directed graph of nodes.

8. The computer-implemented method of claim 7, wherein a respective subsection of the two or more independent subsections begins at a respective initial subsection node in the router network and is determined to be independent if subsequent nodes in the respective subsection do not connect via an edge to any nodes outside of the respective subsection.

9. The computer-implemented method of claim 8, further comprising:
subsequent to partitioning, by the first computing system, the directed graph of nodes into the router network and the two or more partitions, updating, by the first computing system, the router network to include a reference to a location of the remotely located second computing system storing the respective service container storing the respective partition.

10. The computer-implemented method of claim 9, wherein the reference to the location of the remotely located second computing system is associated with the initial subsection node in the router network.

11. The computer-implemented method of claim 10, further comprising:
receiving, by the first computing system, an input request;
evaluating, by the first computing system, the input request using the router network, beginning at the root node and following the directed graph of nodes until the first computing system reaches the initial subsection node associated with the respective partition;
identifying, by the first computing system, the location of the remotely located second computing system storing the respective service container storing the respective partition; and
transmitting, by the first computing system, at least a portion of the input request to the remotely located second computing system storing the respective service container storing the respective partition.

12. The computer-implemented method of claim 11, wherein the input request includes an object to be evaluated based on the rule-based system.

13. The computer-implemented method of claim 12, further comprising:
applying, by the first computing system, at a respective node, a rule associated with the respective node to the object;
generating, by the first computing system, an outcome of the rule associated with the respective node;
providing, by the first computing system, the outcome of the rule to at least one additional node based on one or more edges connecting to the respective node; and
continuing, by the first computing system, to apply rules associated with each additional node until the first computing system reaches an end of the directed graph of nodes or a reference to the respective service container located at the remotely located second computing system that stores the respective service container.

14. The computer-implemented method of claim 13, wherein the end of the directed graph of nodes includes an outcome node of the directed graph of nodes.

15. The computer-implemented method of claim 14, wherein the outcome node is associated with an action.

16. The computer-implemented method of claim 15, further comprising:
performing, by the first computing system, the action associated with the outcome node.

17. The computer-implemented method of claim 1, wherein the directed graph of nodes is associated with providing a service and wherein the respective partition of the two or more partitions is associated with a sub-service of the service.

18. The computer-implemented method of claim 1, wherein the service container is a package of software that contains all necessary elements to execute on the remotely located second computing system.

19. A first computing system, comprising:
a system memory; and
a processor device communicatively coupled to the system memory to:
access a directed graph of nodes, wherein the directed graph of nodes represents a rule-based system for evaluating input;
partition the directed graph of nodes into a router network and two or more partitions, each partition comprising an independent subsection of the directed graph of nodes; and
for a respective partition of the two or more partitions:
generate a respective service container to store the respective partition; and
transmit the respective service container to a remotely located second computing system for execution on the remotely located second computing system.

20. A non-transitory computer-readable storage medium that includes executable instructions to cause a processor device to:
access a directed graph of nodes, wherein the directed graph of nodes represents a rule-based system for evaluating input;
partition the directed graph of nodes into a router network and two or more partitions, each partition comprising an independent subsection of the directed graph of nodes; and
for a respective partition of the two or more partitions:
generate a respective service container to store the respective partition; and
transmit the respective service container to a remotely located second computing system for execution on the remotely located second computing system.
